(19) United States
(12) Patent Application Publication
(10) Pub. No.: US 2014/0292578 A1
(43) Pub. Date: Oct. 2, 2014

(54) BEAM STEERING ANTENNA METHOD FOR UNMANNED VEHICLE

(71) Applicants: KING FAHD UNIVERSITY OF PETROLEUM AND MINERALS, DHAHRAN (SA); KING ABDULAZIZ CITY FOR SCIENCE AND TECHNOLOGY, RIYADH (SA)

(72) Inventors: MOHAMED ADEL MAHMOUD MOHAMED IBRAHIM, DHAHRAN (SA); MOHAMMAD SAID SHARAWI, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/851,062

(22) Filed: Mar. 26, 2013

(51) Int. Cl. H01Q 3/34

(52) U.S. Cl. CPC H01Q 3/34
USPC 342/368

(57) ABSTRACT

The beam steering antenna method for unmanned vehicles includes circuits that automatically execute an algorithm in an unmanned vehicle (UV) that enhances the communication link by steering the beam of a patch antenna array to the direction of the maximum received signal strength (RSS) utilizing a received signal strength indicator (RSSI) module. The algorithm can be used on both unmanned ground vehicles (UGV) and unmanned aerial vehicles (UAV). The algorithm was tested through a simulation environment that integrates a virtual feasible aircraft trajectory and an antenna radiation pattern generator. The designed algorithm is simple and fast enough to be executed in real time using a very small hardware platform that can fit inside a small size, low payload vehicle.

### BACKGROUND OF THE INVENTION

1. Field of the Invention

The present invention relates to phased antenna arrays and beam steering antennas, and particularly to a beam steering antenna method for unmanned vehicles to steer the antenna beam to improve communication links based on detected RSSI (received signal strength indication) of the other station's signal.

2. Description of the Related Art

Microstrip patch antennas usually comprise just one square or circular metal antenna element attached to a low-loss dielectric substrate. The substrate is mounted on a larger ground plane, which serves as the return path for current induced on the patch element. The microstrip patch antenna performs optimally when it is sized such that the cavity beneath the patch resonates in its fundamental mode (TM₁₀₀ or TM₀₁₀) at the frequency of interest. This occurs when the resonant dimension of the patch is approximately one half-wavelength long within the dielectric substrate. Circularly polarized reception is possible when both the TM₁₀₀ and TM₀₁₀ modes (transverse magnetic modes) are excited with equal strength, but with a 90° phase shift. Circular polarization is important, since most navigation satellites transmit circularly polarized radiation, and therefore a circularly polarized receive antenna is preferred for optimal system performance. Microstrip patch antennas inherently possess a narrow bandwidth and are suitable for beam steering applications.

Unmanned aerial vehicles (UAV) are automated vehicles that communicate with ground stations via both a control link and a data link. The control link has a low frequency of operation, and therefore is suitable for long range communications. The data link is used for transmitting sensory data to the ground station, and usually operates at high frequency, e.g., in the 2.45 GHz band. The data link has short range because of its high frequency. It is possible to extend the range of the data link by using a high gain antenna array in the UAV that radiates a directive beam focused towards the ground station. However, this requires that the UAV be able to localize and track the location of the ground station in order to steer the beam and keep the beam directed at the ground station. GPS technology is not adequate for this purpose, since GPS signals can be jammed or suffer from interference.

Thus, a beam steering antenna method for unmanned vehicles solving the aforementioned problems is desired.

### SUMMARY OF THE INVENTION

The beam steering antenna method for unmanned vehicles is an automated method for maintaining a communications link between an unmanned vehicle and a control station. The unmanned vehicle has an array of phased antennas embedded therein and a circuit for making RSSI (received signal strength indication) level measurements connected to the antenna array. The method uses a signal processing circuit to scan signals received from the control station, measuring the RSSI levels in an elliptical pattern around the array according to a search algorithm, and determining the direction of the received signal by adjusting the phase parameters of the antennas. The method maintains the communication link by adjusting the directivity of the antenna array by adjusting the phase of the signals at the antennas. The search algorithm can find the direction of the maximum incoming signal in less than 400 ms.

These and other features of the present invention will become readily apparent upon further review of the following specification and drawings.

### BRIEF DESCRIPTION OF THE DRAWINGS

FIG. 1 is a diagrammatic perspective view of a UAV with onboard processor executing a beam steering antenna method for unmanned vehicles according to the present invention.

FIG. 2 is a top plan view of a 2×6 patch antenna array utilized with the beam steering antenna method for unmanned vehicles according to the present invention.

FIG. 3 is a 3-dimensional plot of the radiation pattern of a single patch antenna of the array of FIG. 2.

FIG. 4A is a plot showing the total radiation pattern of the 2×6 patch array of FIG. 2 at zero steering angles.

FIG. 4B is a contour plot showing the total radiation pattern of the 2×6 patch array of FIG. 2 at zero steering angles.

FIG. 5A shows a two-dimensional θ cut of the radiation pattern of the 2×6 patch array of FIG. 2 at different beam steering angles (θ_{b}=45°, φ_{b}=60°).

FIG. 5B shows a two-dimensional θ cut of the radiation pattern of the 2×6 patch array of FIG. 2 at different beam steering angles (θ_{b}=45°, φ_{b}=60°).

FIG. 6 shows the search space in a beam steering antenna method for unmanned vehicles according to the present invention, where the contour plot represents the RSS distribution.

FIG. 7 is a flowchart of the beam steering antenna method for unmanned vehicles according to the present invention, where the initialization step prepares for constructing the ellipse whose edge will contain all the points where an RSS reading will be taken.

FIG. 8 is a plot showing simulation results for 300 different virtual aircraft trajectories in testing of a beam steering antenna method for unmanned vehicles according to the present invention.

FIG. 9 is a plot showing the errors in the RSS in testing of the beam steering antenna method for unmanned vehicles according to the present invention.

Similar reference characters denote corresponding features consistently throughout the attached drawings.

### DETAILED DESCRIPTION OF THE PREFERRED EMBODIMENTS

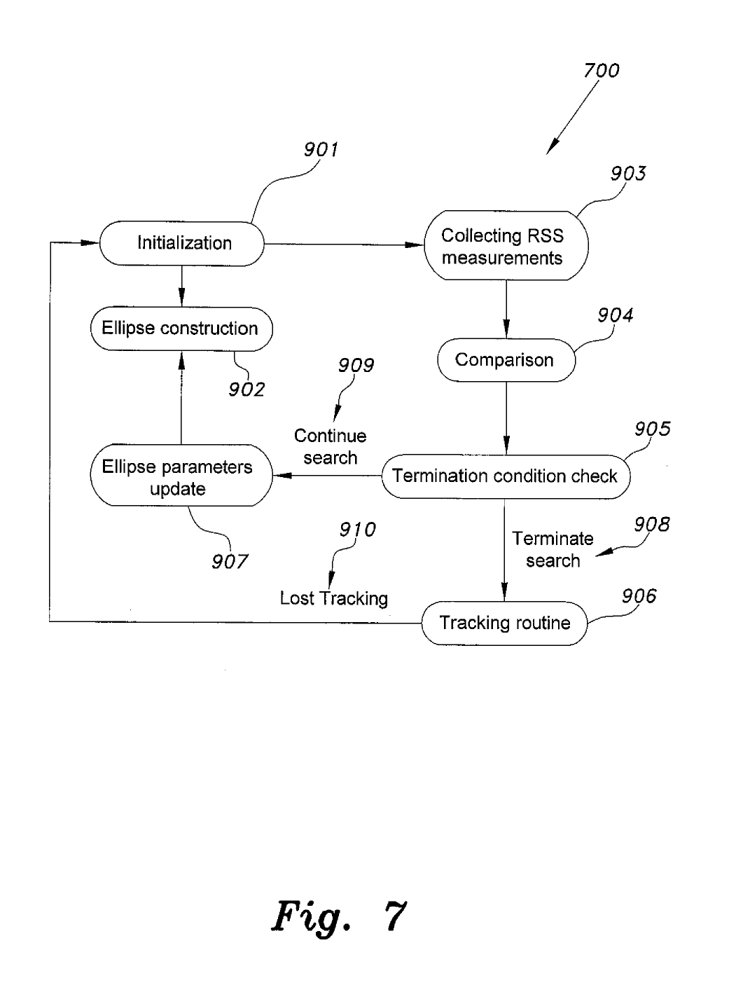

The beam steering antenna method for unmanned vehicles includes (as shown in FIG. 7) an initialization step 901, followed by a construction step 902 that constructs an ellipse 804 whose edge will contain all the points 809 where an RSS (received signal strength) reading needs to be taken and evaluated by the beam steering algorithm. RSS measurements are collected at step 903. A comparison is performed at step 904. A termination condition check is performed at step 905. If the search is to continue, ellipse parameters are updated at step 907 and fed back to be used in the ellipse construction step 902. If the search is to be terminated, the tracking routine is executed at step 906.

The ellipse has 4 parameters that need to be defined before construction. These parameters are r_{θ} 802, r_{φ} 805, the ellipse center, and n, where n is the number of points on the ellipse edge. For example, in the example shown in FIG. 6, the value of n is 8. These four parameters are defined initially in the initialization block 901 according to the antenna array characteristics.

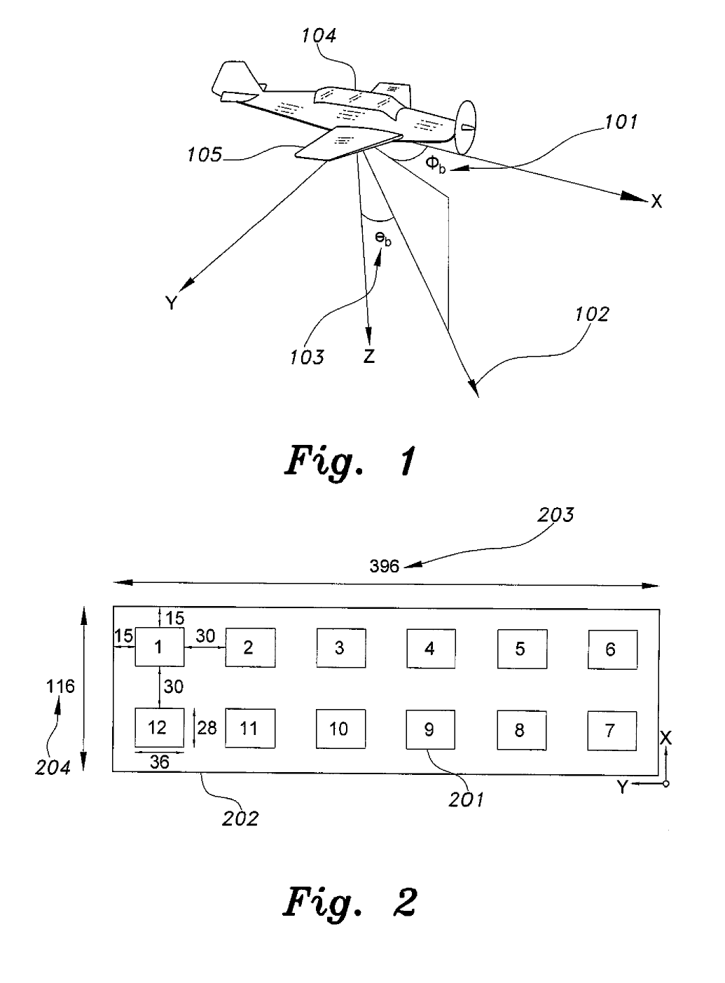

FIG. 1 shows an exemplary UAV 104 in its vehicle-centered coordinate system. The antenna array is embedded inside the wing structure 105 so that the patches are facing downwards along the z-axis. The antenna beam 102 is directed and steered for any given spherical steering angles θ_{b} 103 and φ_{b} 101, where the subscript b is short for beam. The steering angle φ_{b} can have any value between 0° and 360° while the other steering angle θ_{b} can only have values between 0° and 180°.

FIG. 2 shows an example of a designed 2×6 patch antenna array, where its length 203 is 396 mm and its width 204 is 116 mm. The inter element spacing is 30 mm, and the dimensions of the patches 201 are 36×28 mm. The array has 12 patch elements 201 and a common ground plane 202. These dimensions were made according to a specific UAV size. They can be redesigned to accommodate any vehicle size.

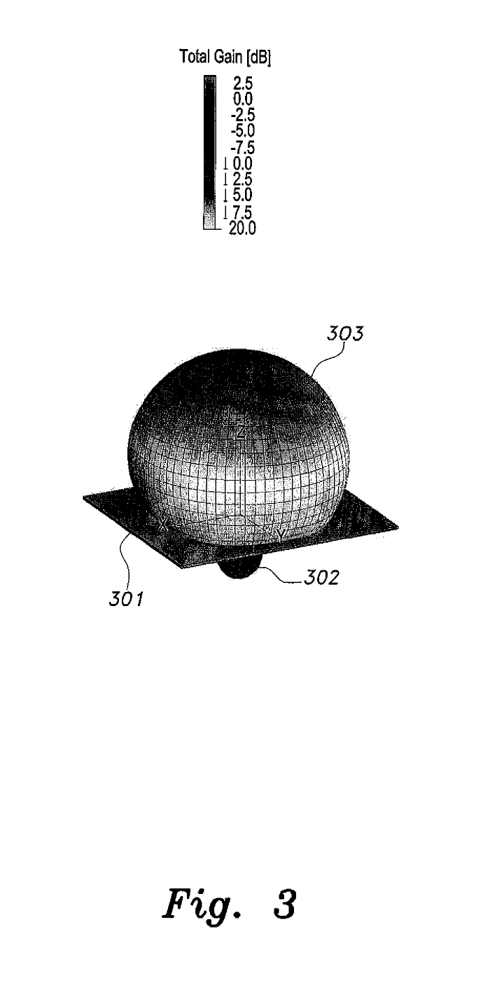

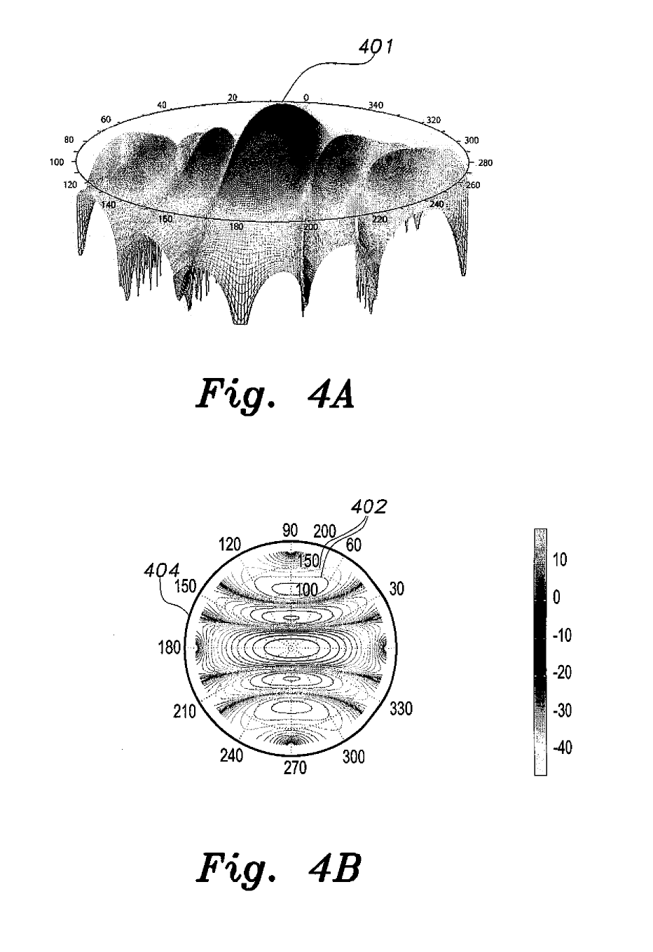

FIG. 3 shows the radiation pattern of a single patch antenna 301 simulated using an electromagnetic simulation tool. The back lobe 302 is very small compared to the main lobe 303 which is nearly spherical, thus enabling a smooth beam steering capabilities for the array shown in FIG. 2.

FIG. 4A shows the total radiation pattern of the 2×6 patch array at zero steering angles (θ_{b}=0, φ_{b}=0). The circular axis 401 represents the angle φ and the mesh shading and structure represents the total gain.

FIG. 4B shows the same radiation pattern shown in FIG. 4A as a contour plot, where the contour lines' shading represents the total gain in dB according to the legend bar. The circular axis 404 represents the angle φ while the concentric circles 402 represent the angle θ.

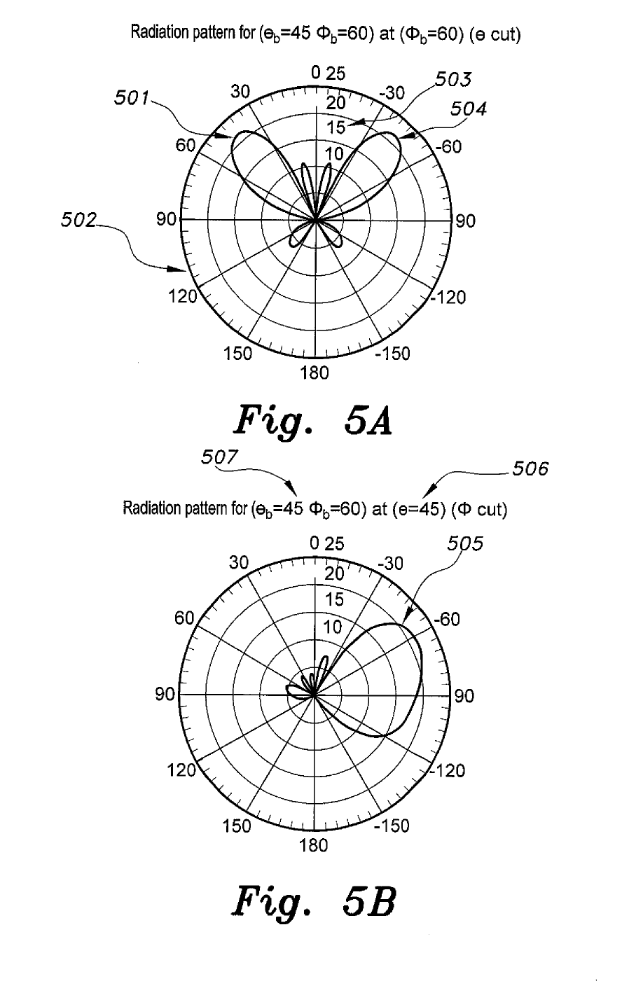

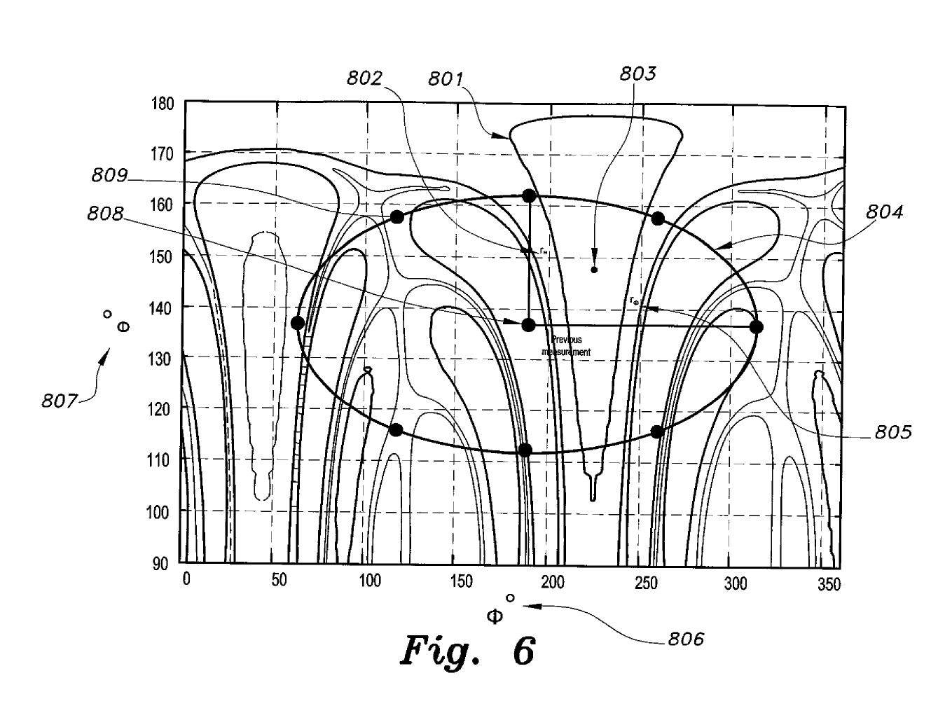

FIG. 5A shows a two-dimensional θ cut of the radiation pattern at different beam steering angles (θ_{b}=45°, φ_{b}=60°). The circular axis 502 represents the angle θ, while φ is fixed at 60°. The concentric circles scale represents the gain in dB. Notice that at these steering angles for the particular cut taken, the antenna produces two different lobes 504 and 501 with nearly the same gain and narrow half power beam width (HPBW).

FIG. 5B shows another two-dimensional cut, yet it is a φ cut this time, where the beam steering angles 507 are (θ_{b}=45°, φ_{b}=60°) and θ 506 is fixed at 45°. Notice the presence of an only one main lobe 505 and a wide HPBW.

FIG. 6 shows the search space, where the contour plot represents the RS S distribution. The search space spans in the φ-axis 806 (φₛₚₐₙ) for 360° and in the θ-axis 807 (θₛₚₐₙ) for 90°. The contour line 801 represents the area of maximum RSS, where the point 803 represents the absolute maximum RSS point, which is the target of the present search algorithm.

With respect to the ellipse construction step 902 of algorithm 700 (FIG. 7), in order to define the parameters of the first ellipse, the minimum half-power beamwidth “HPBWₘᵢₙ” is selected out of the two values, HPBW_{φ}, and HPBW_{θ}. Then, using the value of HPBWₘᵢₙ in equation (1), the initial value for r is obtained:

$${r}_{{φ}_{initial}} = \frac{1}{2} [ {φ}_{span} - \frac{{HPBW}_{min}}{2} ] . \qquad ( 1 )$$

Equation (1) guarantees that the ellipse initially covers the region containing the maximum RSS.

The value of r_{θ}_{ᵢₙᵢₜᵢₐₗ} is accordingly calculated using equation (2), where this ratio must hold in all the algorithm iterations in order to match the search space at hand:

$$\frac{{r}_{θ}}{{r}_{φ}} = \frac{{θ}_{span}}{{φ}_{span}} . \qquad ( 2 )$$

The ellipse center is assumed initially at the center of the search space. The last ellipse parameter that requires initialization is n, which is calculated initially according to equation (3). However, it must then be approximated to the nearest highest number divisible by 4. This approximation is done so that the produced points 809 will be symmetric around the ellipse center 808:

$${n}_{initial} = \frac{{r}_{{φ}_{initial}}}{\frac{1}{2} {HPBW}_{min}} \qquad ( 3 )$$

After the algorithm is initialized at step 901, the first ellipse points are calculated at step 902, and an RSS reading is made at step 903 and associated with each point 809 shown in FIG. 6. Then, a comparison between all of these values is made at step 904 and the highest RSS point 808 shown in FIG. 6 is selected to be the center of the next ellipse to be constructed in the next algorithm iteration, if the algorithm wasn't terminated by the termination condition check made in every iteration at step 905.

The termination condition of step 905 compares the RSS recorded from the previous iteration and the RSS produced from the current iteration, and if that difference exceeds 0.4 dB, it proceeds with the next iteration 909. Otherwise, the improvement is not considered significant enough, and the algorithm is terminated 908. Another termination condition is constrained by the time consumed by the algorithm, and it is set at 2000 ms as a maximum allowable time for the algorithm. These parameters can be tuned based on the environment and the application at hand.

If the termination conditions 905 are not satisfied and further iterations are needed 909, the new ellipse to be constructed will have different parameters, and this is why these parameters are updated 907 before constructing the new ellipse 902. Ellipse parameters are updated every iteration according to equations (4), (5), and (6) as follows:

r_{φ}(k+1)=r_{φ}(k)*fᵣ, (4)

where k is the iteration counter and fᵣ represents a reduction factor whose value is in the range [0-1], and it needs to be tuned for better results. In our case, it was (0.8). Then:

$${r}_{θ} ( k + 1 ) = \frac{{θ}_{span}}{{φ}_{span}} * {r}_{φ} ( k + 1 ) . \qquad ( 5 )$$

The center of the new ellipse 808 is the point at which the maximum RSS is obtained in the previous iteration. Then, the number of ellipse points n is updated for the next iteration according to equation (6):

n(k+1)=n(k)*fₙ, (6)

where fₙ represents another reduction factor whose value can be tuned. In our case it was (0.5). At the end of the search procedure, the algorithm will provide its best estimation for the steering angles θ_{b} and φ_{b} that gives the maximum RSS.

When one of the termination conditions is satisfied, the search process is terminated 908, and the tracking routine takes over at step 906. The tracking routine 906 is a simple version of the search algorithm. The tracking routine conducts only one search iteration based on the last recorded values for the ellipse parameters. This is executed every fixed amount of tune according to the wireless communications protocol followed by the transceiver onboard the UAV 104 such that it doesn't interfere with the data packets being transmitted. If the transceiver is not in the transmitting mode, then the search algorithm can be executed smoothly without interfering with the received data because it needs only the RSS values coming out of the receiver.

If the RSS degraded dramatically in a short period of time, the tracking routine at step 906 will deduce that the antenna beam 102 has become misaligned with the maximum RSS, i.e., at step 910 the software reports that the beam has lost track of the maximum RSS. Thus, the algorithm initiates another search process to produce more accurate values for the steering angles.

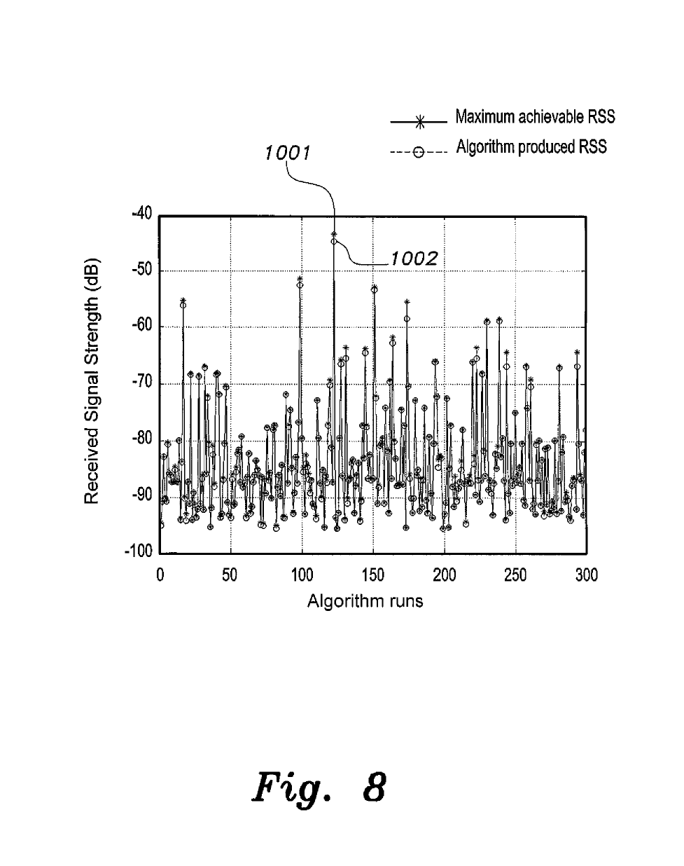

FIG. 8 shows the simulation results for 300 different virtual aircraft trajectories. For each one of the 300 runs, we have two RSS values. One RSS value 1002 represents the RSS achieved by the algorithm, and the other RSS value 1001 represents the maximum achievable RSS produced by a perfect beam steering.

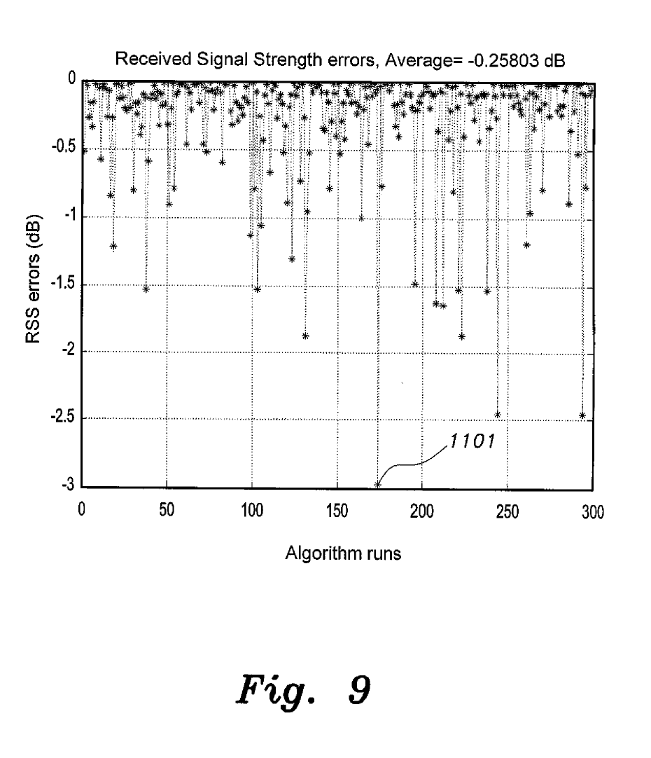

FIG. 9 shows the errors in the RSS. This is the difference between the maximum achievable RSS and the RSS achieved by the algorithm. Notice that the average error value is −0.25 dB, and the maximum error 1101 doesn't exceed −3 dBs.

The average Time of convergence (TOC) for the 300 runs, i.e., the average time period consumed by the algorithm before producing its output was demonstrated to be approximately 403.3 ms.

It will be understood that the diagrams in the Figures depicting the beam steering antenna method are exemplary only, and may be embodied in a dedicated electronic device having a microprocessor, microcontroller, digital signal processor, application specific integrated circuit, field programmable gate array, any combination of the aforementioned devices, or other device that combines the functionality of the beam steering method onto a single chip or multiple chips programmed to carry out the method steps described herein, or may be embodied in a general purpose computer having the appropriate peripherals attached thereto and software stored on a non-transitory computer readable media that can be loaded into main memory and executed by a processing unit to carry out the functionality of the inventive apparatus and steps of the inventive method described herein.

It is to be understood that the present invention is not limited to the embodiments described above, but encompasses any and all embodiments within the scope of the following claims.

We claim:

1. A beam steering antenna method for an unmanned vehicle, the unmanned vehicle having an antenna for communicating with a control station, the method comprising the steps of:
initializing beam steering ellipse parameters, the parameters being r_{θ}, r_{φ}, the ellipse center, and n, where n is the number of points on the ellipse edge;
iteratively constructing the ellipse, the points on the elliptical edge defining a scan search space for a signal around the unmanned vehicle;
conducting over the scan search space an RSSI (received signal strength indication) signal scan in an azimuth angle defined by r_{θ}, and an elevation angle defined by r_{φ}, the RSSI signal scan being logged for signal comparison purposes;
identifying RSSI maxima based on comparisons of the logged RSSI signal scans;
updating parameters of the ellipse;
repeating the steps of constructing the ellipse, conducting an RSSI scan, identifying the RSSI maxima, and updating the parameters of the ellipse until a termination condition has been met; and
tracking the signal by steering the antenna based on the azimuth angle and the elevation angle of the identified RSSI maximum when the termination condition is met.

2. The beam steering antenna method for an unmanned vehicle according to claim 1, wherein said initialization step further comprises the steps of:
selecting the minimum of the half-power bandwidth in the φ direction (HPBW_{φ}) and the half-power bandwidth in the θ direction (HPBW_{θ});
calculating r_{φ}_{ᵢₙᵢₜᵢₐₗ} according to the equation characterized by the relation:
$${r}_{{φ}_{initial}} = \frac{1}{2} [ {φ}_{span} - \frac{{HPBW}_{min}}{2} ] ,$$
thereby assuring that the ellipse initially covers the region containing the maximum RSS;
calculating r_{θ}_{ᵢₙᵢₜᵢₐₗ} according to the equation characterized by the relation:
$$\frac{{r}_{θ}}{{r}_{φ}} = \frac{{θ}_{span}}{{φ}_{span}} ;$$
and
calculating nᵢₙᵢₜᵢₐₗ according to the equation characterized by the relation:
$${n}_{initial} = \frac{{r}_{{φ}_{initial}}}{\frac{1}{2} {HPBW}_{min}} .$$

3. The beam steering antenna method for an unmanned vehicle according to claim 2, wherein said step of updating the parameters of the ellipse further comprises the steps of:
calculating r_{φ}(k+1) according to the equation characterized by the relation:
r_{φ}(k+1)=r_{φ}(k)*fᵣ,
where k is the iteration counter and fᵣ represents a first reduction factor whose value is in the range [0-1];
calculating r_{θ}(k+1) according to the equation characterized by the relation:
$${r}_{θ} ( k + 1 ) = \frac{{θ}_{span}}{{φ}_{span}} * {r}_{φ} ( k + 1 ) ;$$
and
calculating n(k+1) according to the equation characterized by the relation:
n(k+1)=n(k)*fₙ,
where fₙ represents a second reduction factor whose value can be tuned.

4. The beam steering antenna method for an unmanned vehicle according to claim 3, wherein the antenna is a patch antenna array having a plurality of patch elements and a common ground plane.

5. A beam steering antenna system for unmanned vehicles, comprising:
a steerable array of phased antennas;
means for initializing beam steering ellipse parameters, the parameters being r_{θ}, r_{φ}, the ellipse center, and n, where n is the number of points on the ellipse edge;
means for constructing the ellipse, the points on the elliptical edge defining a scan search space around the unmanned vehicle for a signal;
means for conducting over the scan search space an RSSI signal scan in an azimuth angle defined by r_{θ}, and an elevation angle defined by r_{φ}, the RSSI signal scan being logged for signal comparison purposes;
means for identifying RSSI maxima based on comparison of the logged RSSI signal scans;
means for updating parameters of the ellipse;
means for iteratively constructing the ellipse, conducting the RSSI scan, identifying the RSSI maxima, and updating the parameters of the ellipse until a termination condition has been met; and
means for steering the antenna array based on the azimuth angle and the elevation angle of the identified RSSI maximum when the termination condition is met.

6. The beam steering antenna system for an unmanned vehicle according to claim 5, wherein said initialization means further comprises:
means for selecting the minimum of the half-power bandwidth in the φ direction (HPBW_{φ}) and the half-power bandwidth in the θ direction (HPBW_{θ});
means for calculating r_{φ}_{ᵢₙᵢₜᵢₐₗ} according to the equation characterized by the relation:
$${r}_{{φ}_{initial}} = \frac{1}{2} [ {φ}_{span} - \frac{{HPBW}_{min}}{2} ] ,$$
thereby assuring that the ellipse initially covers the region containing the maximum RSS;
means for calculating r_{θ}_{ᵢₙᵢₜᵢₐₗ} according to the equation characterized by the relation:
$$\frac{{r}_{θ}}{{r}_{φ}} = \frac{{θ}_{span}}{{φ}_{span}} ;$$
and
means for calculating nᵢₙᵢₜᵢₐₗ according to the equation characterized by the relation:
$${n}_{initial} = \frac{{r}_{{φ}_{initial}}}{\frac{1}{2} {HPBW}_{min}} .$$

7. The beam steering antenna system for an unmanned vehicle according to claim 6, wherein said ellipse parameter update means further comprises:
means for calculating r_{φ}(k+1) according to the equation characterized by the relation:
r_{φ}(k+1)=r_{φ}(k)*fᵣ,
where k is the iteration counter and fᵣ represents a first reduction factor whose value is in the range [0-1];
means for calculating r_{θ}(k+1) according to the equation characterized by the relation,
$${r}_{θ} ( k + 1 ) = \frac{{θ}_{span}}{{φ}_{span}} * {r}_{φ} ( k + 1 ) ;$$
and
means for calculating n(k+1) according to the equation characterized by the relation:
n(k+1)=n(k)*fₙ,
where fₙ represents a second reduction factor whose value can be tuned.

8. The beam steering antenna method for an unmanned vehicle according to claim 7, wherein each said antenna is a patch antenna array having a plurality of patch elements and a common ground plane.

9. A computer software product, comprising a non-transitory medium readable by a processor, the non-transitory medium having stored thereon a set of instructions for beam steering an antenna disposed in a vehicle, the set of instructions including:
(a) a first sequence of instructions which, when executed by the processor, causes said processor to initialize beam steering ellipse parameters, said parameters being r_{θ}, r_{φ}, the ellipse center, and n, where n is the number of points on the ellipse edge;
(b) a second sequence of instructions which, when executed by the processor, causes said processor to iteratively construct said ellipse, said points on the elliptical edge defining a scan search space around said vehicle;
(c) a third sequence of instructions which, when executed by the processor, causes said processor to conduct over said scan search space an RSSI signal scan in an azimuth angle defined by r_{θ}, and an elevation angle defined by r_{φ}, said RSSI signal scan being logged for signal comparison purposes;
(d) a fourth sequence of instructions which, when executed by the processor, causes said processor to identify RSSI maxima based on comparisons of said logged RSSI signal scans;
(e) a fifth sequence of instructions which, when executed by the processor, causes said processor to update parameters of said ellipse;
(f) a sixth sequence of instructions which, when executed by the processor, causes said processor to repeat the ellipse construction step, RSSI scan step, RSSI maxima identification step, and ellipse parameter updating step until a termination condition has been met; and
(g) a seventh sequence of instructions which, when executed by the processor, causes said processor to track said signal by steering said antenna based on said θ and said φ angles of said identified RSSI maxima.

10. The computer software product according to claim 9, further comprising:
an eighth sequence of instructions which, when executed by the processor, causes said processor to select the minimum of half power bandwidth in the φ direction (HPBW_{φ}) and half power bandwidth in the θ direction (HPBW_{θ});
a ninth sequence of instructions which, when executed by the processor, causes said processor to calculate r_{φ}_{ᵢₙᵢₜᵢₐₗ} according to the equation characterized by the relation,
$${r}_{{φ}_{initial}} = \frac{1}{2} [ {φ}_{span} - \frac{{HPBW}_{min}}{2} ] ,$$
thereby assuring that said ellipse initially covers the region containing the maximum RSS;
a tenth sequence of instructions which, when executed by the processor, causes said processor to calculate r_{θ}_{ᵢₙᵢₜᵢₐₗ} according to the equation characterized by the relation,
$$\frac{{r}_{θ}}{{r}_{φ}} = \frac{{θ}_{span}}{{φ}_{span}}$$
and
an eleventh sequence of instructions which, when executed by the processor, causes said processor to calculate nᵢₙᵢₜᵢₐₗ according to the equation characterized by the relation,
$${n}_{initial} = \frac{{r}_{{φ}_{initial}}}{\frac{1}{2} {HPBW}_{min}} .$$

11. The computer software product according to claim 10, further comprising:
a twelfth sequence of instructions which, when executed by the processor, causes said processor to calculate r_{φ}(k+1) according to the equation characterized by the relation,
r_{φ}(k+1)=r_{φ}(k)*fᵣ,
where k is the iteration counter and fᵣ represents a first reduction factor whose value is in the range [0-1];
a thirteenth sequence of instructions which, when executed by the processor, causes said processor to calculate r_{θ}(k+1) according to the equation characterized by the relation:
$${r}_{θ} ( k + 1 ) = \frac{{θ}_{span}}{{φ}_{span}} * {r}_{φ} ( k + 1 ) ;$$
and
a fourteenth sequence of instructions which, when executed by the processor, causes said processor to calculate n(k+1) according to the equation characterized by the relation,
n(k+1)=n(k)*fₙ,
where fₙ represents a second reduction factor whose value can be tuned.

12. The computer software product according to claim 11, further comprising a fifteenth sequence of instructions which, when executed by the processor, causes said processor to perform said beam steering utilizing a patch antenna array having a plurality of patch elements and a common ground plane.
